(19) United States
(12) Patent Application Publication
(10) Pub. No.: US 2024/0322237 A1
(43) Pub. Date: Sep. 26, 2024

(54) RECHARGEABLE LITHIUM BATTERY

(71) Applicant: SAMSUNG SDI CO., LTD., Yongin-si (KR)

(72) Inventors: Seungryong OH, Yongin-si (KR); Jeongmin SHIN, Yongin-si (KR); Myunghoon KIM, Yongin-si (KR); Aeran KIM, Yongin-si (KR); Yunhee KIM, Yongin-si (KR); Injun PARK, Yongin-si (KR)

(21) Appl. No.: 18/493,625

(22) Filed: Oct. 24, 2023

(30) Foreign Application Priority Data
Feb. 24, 2023 (KR) 10-2023-0025407

(51) Int. Cl. H01M 10/0567; H01M 4/36; H01M 4/38; H01M 4/525; H01M 4/587; H01M 10/0525; H01M 10/0568

(52) U.S. Cl. CPC H01M 10/0567; H01M 4/366; H01M 4/386; H01M 4/525; H01M 4/587; H01M 10/0525; H01M 10/0568; H01M 2004/021; H01M 2300/0025

(57) ABSTRACT

A rechargeable lithium battery includes a positive electrode including a positive electrode active material; a negative electrode including a negative electrode active material; and an electrolyte solution including a non-aqueous organic solvent, a lithium salt, and an additive, wherein the negative electrode active material includes a Si composite, the additive includes a compound represented by Chemical Formula 1, the lithium salt includes a compound represented by Chemical Formula 2, and the compound represented by Chemical Formula 2 is included in an amount of about 5 to about 70 wt % based on 100 wt % of the total amount of the lithium salt.

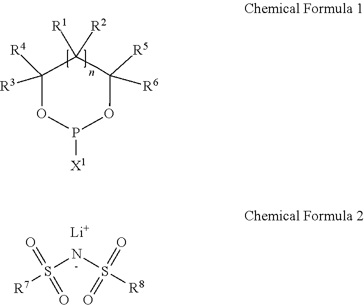

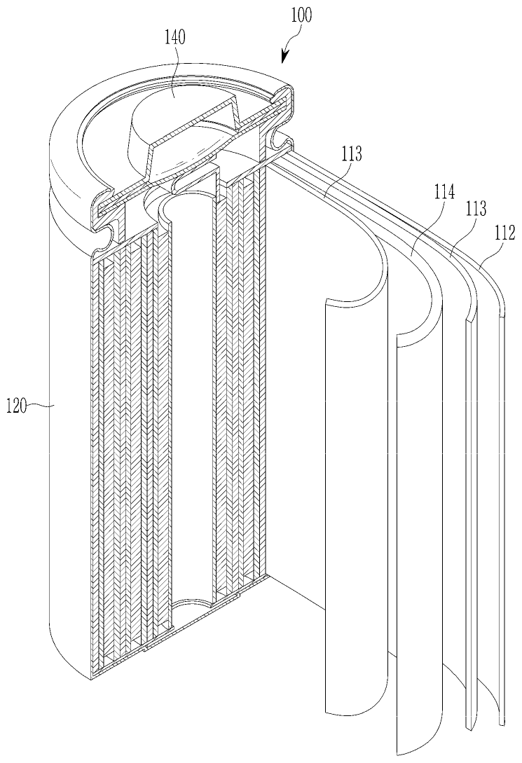

### CROSS-REFERENCE TO RELATED APPLICATION

The present application claims priority to and the benefit of Korean Patent Application No. 10-2023-0025407, filed on Feb. 24, 2023, in the Korean Intellectual Property Office, the entire content of which is incorporated herein by reference.

### BACKGROUND

### 1, Field

One or more embodiments of the present disclosure relate to a rechargeable lithium battery.

### 2. Description of the Related Art

A rechargeable lithium battery may be recharged and has three or more times the (higher) energy density per unit weight as a comparable lead storage battery, nickel-cadmium battery, nickel hydrogen battery, nickel zinc battery and/or the like. The rechargeable lithium battery may be charged at a relatively high rate and thus, is commercially manufactured for a laptop, a cell phone, an electric tool, an electric bike, and/or the like. Research on improvement of additional energy density of the rechargeable lithium battery has been actively made and pursued.

In particular, as information technology (IT) related devices increasingly achieve high performance, a high-capacity battery is required and desired Here, the high capacity may be realized through expansion of a voltage range, which increases energy density but also brings about a problem of deteriorating performance of a positive electrode due to oxidization of an electrolyte solution in the high voltage range (e.g., at a high voltage).

For example, LiPF₆, which is often utilized as a lithium salt of the electrolyte solution, reacts with a solvent of the electrolyte solution to promote depletion of the solvent and generate a large amount of gas. LiPF₆ is decomposed and produces a decomposition product such as HF, PF₅, and/or the like, which causes depletion of the electrolyte solution and leads to performance deterioration and possibly insufficient safety at a high temperature.

The decomposition products of the electrolyte solution may also be deposited into a film on the surface of an electrode and this may increase internal resistance of the battery and eventually cause problems and/or issues of deteriorating battery performance and shortening the cycle-life (and life cycle) of the battery. In particular, this side reaction is further accelerated at a high temperature where a reaction rate becomes faster, and gas components generated due to the side reaction may rapidly increase an internal pressure of the battery and thus may have a substantial adverse effect on stability of the battery.

An oxidization of the electrolyte solution in the high voltage range (e.g., at a high voltage) is accelerated and thus may also greatly increase resistance of the electrode during the long-term charge and discharge process.

Accordingly, an electrolyte solution applicable under conditions of a high voltage and a high temperature condition is being required and highly desired.

### SUMMARY

One or more aspects of embodiments of the present disclosure are directed toward a rechargeable lithium battery that has improved battery stability by suppressing decomposition of an electrolyte solution and side reactions with an electrode to suppress or reduce an increase in battery internal resistance, and concurrently (e.g., simultaneously), has improved cycle-life characteristics at high temperature and at room temperature due to increased capacity.

Additional aspects will be set forth in part in the description which follows and, in part, will be apparent from the description, or may be learned by practice of the presented embodiments of the disclosure.

According to one or more embodiments, a rechargeable lithium battery includes a positive electrode including a positive electrode active material; a negative electrode including a negative electrode active material; and an electrolyte solution including a non-aqueous organic solvent, a lithium salt, and an additive, wherein the negative electrode active material includes a Si composite (e.g., in particle form, e.g., being in the form of a particle or particles), the additive includes a compound represented by Chemical Formula 1, the lithium salt includes a compound represented by Chemical Formula 2, and the compound represented by Chemical Formula 2 is in an amount of about 5 to about 70 wt % based on 100 wt % of a total amount (e.g., a total weight) of the lithium salt.

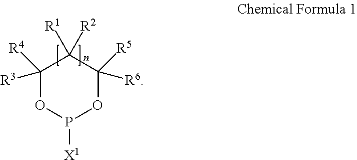

### In Chemical Formula 1,

X¹ may be a fluoro group, a chloro group, a bromo group, or an iodo group;
R¹ to R⁶ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group; and
n may be an integer of 0 or 1;

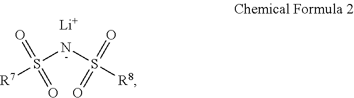

wherein, in Chemical Formula 2,
R⁷ and R⁸ may each independently be a fluoro group or a C1 to C4 fluoroalkyl group substituted with at least one fluoro group.

In one or more embodiments, Chemical Formula 1 may include a compound represented by Chemical Formula 1A or Chemical Formula 1B.

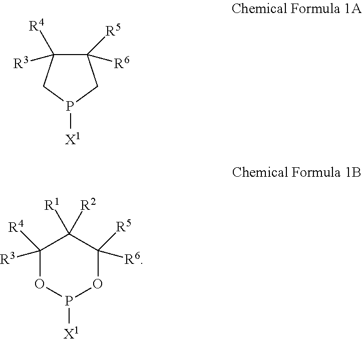

In Chemical Formula 1A and Chemical Formula 1B,
X¹ may be a fluoro group, a chloro group, a bromo group, or an iodo group, and
R¹ to Re may each independently be hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In one or more embodiments, R³ and R⁴ of Chemical Formula 1A may each be hydrogen, and
at least one of R⁵ or R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

The compound represented by Chemical Formula 1 may be in an amount of about 0.1 to about 1 wt % based on 100 wt % of a total amount (e.g., a total weight) of the electrolyte solution.

In one or more embodiments, the Si composite may include a core including Si particles and amorphous carbon.

The core including the Si particles may include at least one selected from among a Si—C composite, SiOₓ (0<x≤2), and a Si alloy.

The Si—C composite (e.g., in particle form, e.g., being in the form of a particle or particles) may include a core including Si particles and amorphous carbon.

A central portion of the core of the Si—C composite may include voids (e.g., pores).

A radius of the central portion of the core of the Si—C composite (e.g., the Si—C composite particle) may correspond to about 30% to about 50% of a radius of the Si—C composite (e.g., the Si—C composite particle), and an average particle diameter of the Si particles may be about 10 nm to about 200 nm.

The central portion may not include (e.g., may exclude) amorphous carbon, and the amorphous carbon may be present only on a surface portion of the negative electrode active material (e.g., on a surface portion of the Si—C composite particle).

In one or more embodiments, the negative electrode active material may further include crystalline carbon.

The crystalline carbon may include graphite, and the graphite may include natural graphite, artificial graphite, or a mixture thereof.

A content (e.g., amount) of the Si composite may be about 1.0 to about 60 wt % based on a total weight of the negative electrode active material.

The amorphous carbon may include soft carbon, hard carbon, mesophase pitch carbonized product, calcined coke, or a mixture thereof.

In one or more embodiments, the compound represented by Chemical Formula 1 may be at least one selected from the compounds of Group 1.

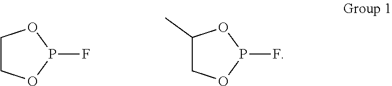

In one or more embodiments, the compound represented by Chemical Formula 2 may include Chemical Formula 2A, Chemical Formula 2B, Chemical Formula 2C, or a combination thereof.

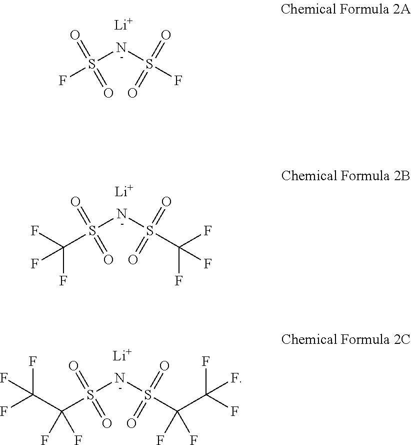 [SMILES: [Li+] ; O=S(=O)(F)NS(=O)(=O)F ; [Li+] ; O=S(=O)(NS(=O)(=O)C(F)(F)F)C(F)(F)F ; [Li+] ; O=S(=O)(NS(=O)(=O)C(F)(F)C(F)(F)F)C(F)(F)C(F)(F)F]

In one or more embodiments, the compound represented by Chemical Formula 2 may be in an amount of about 10 to about 50 wt % based on 100 wt % of the total amount of the lithium salt.

In one or more embodiments, the additive may further include at least one selected from other additives of vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), 1,3,6-hexane tricyanide (HTCN), propene sultone (PST), propane sultone (PS), lithium tetrafluoroborate (LiBF₄), lithium difluorophosphate (LiPO₂F₂), and 2-fluoro biphenyl (2-FBP).

The positive electrode active material may be at least one type or kind of lithium composite oxide represented by Chemical Formula 4.

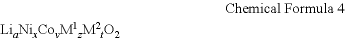

### In Chemical Formula 4,

0.9≤a<1.2, 0.8≤x<1.0, 0<y≤0.2, 0<z≤0.2, x+y+z=1, 0≤t≤0.1,
M¹ is manganese (Mn), aluminum (Al), or a combination thereof, and
M² is nickel (Ni), cobalt (Co), manganese (Mn), aluminum (Al), titanium (Ti), magnesium (Mg), zirconium (Zr), calcium (Ca), niobium (Nb), iron (Fe), phosphorus (P), fluorine (F), boron (B), or a combination thereof.

In some embodiments, in Chemical Formula 4, x may be 0.88≤x<1.0.

According to one or more embodiments of the present disclosure, a rechargeable lithium battery with improved cycle-life characteristics at high temperature and room temperature and suppressed (reduced) increase in internal resistance of the battery may be implemented.

### BRIEF DESCRIPTION OF THE DRAWING

The accompanying drawing is included to provide a further understanding of the present disclosure, and is incorporated in and constitutes a part of this specification. The drawing illustrates example embodiments of the present disclosure and, together with the description, serve to explain principles of present disclosure. In the drawing:

The drawing is a schematic view illustrating a rechargeable lithium battery according to one or more embodiments of the present disclosure.

### DETAILED DESCRIPTION

The present disclosure may be modified in many alternate forms, and thus specific embodiments will be exemplified in the drawing and described in more detail.

It should be understood, however, that it is not intended to limit the present disclosure to the particular forms disclosed, but rather, is intended to cover all modifications, equivalents, and alternatives falling within the spirit and scope of the present disclosure.

Hereinafter, a rechargeable lithium battery according to one or more embodiments will be described in more detail with reference to the accompanying drawings. However, these embodiments are mere examples, the present disclosure is not limited thereto and the present disclosure is defined by the scope of claims and equivalents thereof.

As used herein, when a definition is not otherwise provided, “substituted” refers to a replacement of at least one hydrogen of a substituent or a compound by deuterium, a halogen, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C20 alkoxy group, a cyano group, or a combination thereof.

In one example of the present invention, “substituted” refers to replacement of at least one hydrogen of a substituent or a compound by deuterium, a halogen, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, or a cyano group. In addition, in specific examples of the present invention, “substituted” refers to replacement of at least one hydrogen of a substituent or a compound by deuterium, a halogen, a C1 to C20 alkyl group, a C6 to C30 aryl group, or a cyano group. In addition, in specific examples of the present invention, “substituted” refers to replacement of at least one hydrogen of a substituent or a compound by deuterium, a halogen, a C1 to C5 alkyl group, a C6 to C18 aryl group, or a cyano group. In addition, in specific examples of the present invention, “substituted” refers to replacement of at least one hydrogen of a substituent or a compound by deuterium, a cyano group, a halogen, a methyl group, an ethyl group, a propyl group, a butyl group, a phenyl group, a biphenyl group, a terphenyl group, a trifluoromethyl group, or a naphthyl group.

A rechargeable lithium battery may be classified into a lithium ion battery, a lithium ion polymer battery, or a lithium polymer battery depending on types (kinds) of a separator and an electrolyte utilized. It may also be classified to be cylindrical, prismatic, coin-type or kind, pouch-type or kind, and/or the like depending on shapes thereof. In some embodiments, it may be bulk type or kind or thin film type or kind depending on sizes thereof. Structures and manufacturing methods for lithium ion batteries pertaining to this disclosure are well suitable in the art.

Herein, a cylindrical rechargeable lithium battery will be exemplarily described as an example of the rechargeable lithium battery. The drawing schematically shows the structure of a rechargeable lithium battery according to one or more embodiments of the present disclosure. Referring to the drawing, a rechargeable lithium battery 100 according to one or more embodiments may include a battery cell including a positive electrode 114, a negative electrode 112 facing the positive electrode 114, a separator 113 between the positive electrode 114 and the negative electrode 112, and an electrolyte solution impregnating the positive electrode 114, the negative electrode 112, and the separator 113, a battery case 120 housing the battery cell, and a sealing member 140 sealing the battery case 120.

Hereinafter, a more detailed configuration of the rechargeable lithium battery 100 according to one or more embodiments of the present disclosure will be described.

A rechargeable lithium battery according to one or more embodiments may include a positive electrode, a negative electrode, and an electrolyte solution.

The electrolyte solution may include a non-aqueous organic solvent, a lithium salt, and an additive.

The additive may include a compound represented by Chemical Formula 1.

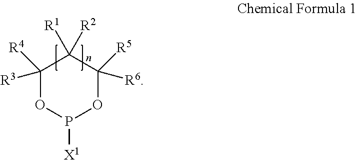

### In Chemical Formula 1,

X¹ may be a fluoro group, a chloro group, a bromo group, or an iodo group,
R¹ to R⁶ may each independently be hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group, and
n may be an integer of 0 or 1.

The compound represented by Chemical Formula 1 has high high-temperature stability on the surface of the negative electrode, forms a solid electrolyte interface (SEI) with excellent or suitable ion conductivity, and suppresses a side reaction of LiPF₆ by a —PO₂F functional group to reduce the gas generation caused by a decomposition reaction of the electrolyte solution during high-temperature storage.

For example, the compound represented by Chemical Formula 1 may be coordinated with a pyrolyzed product of a lithium salt such as LiPF₆ or anions dissociated from the lithium salt and thus form a complex, and the complex formation may stabilize the pyrolyzed product of a lithium salt such as LiPF₆ or the anions dissociated from the lithium salt. Therefore, it may suppress or reduce an undesired side reaction of the anions with the electrolyte solution and prevent or reduce gas generation inside the rechargeable lithium battery and thus greatly reduce a defect rate as well as improve cycle-life characteristics of the rechargeable lithium battery.

In one or more embodiments, the cyclic phospholane derivative contributes to the stabilization of anions dissociated from the pyrolyzed product of the lithium salt or the lithium salt due to the formation of the complex, whereas a linear phosphite derivative may induce a side reaction of LiPF₆ due to the dissociated —PO₂F functional group and causes gas generation due to the decomposition reaction of the electrolyte solution when stored at high temperature. Therefore, if (e.g., when) the compound represented by Chemical Formula 1 including the cyclic phospholane derivative is included, compared to the linear phosphite derivative, cycle-life characteristics of the rechargeable lithium battery may be more remarkably improved.

In one or more embodiments, Chemical Formula 1 may be Chemical Formula 1A or Chemical Formula 1B.

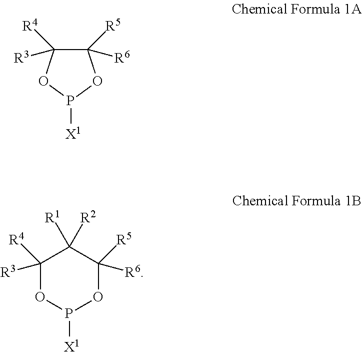

In Chemical Formula 1A and Chemical Formula 1B,
X¹ may be a fluoro group, a chloro group, a bromo group, or an iodo group, and
R¹ to R⁶ may each independently be hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

In one or more embodiments, in Chemical Formula 1A and Chemical Formula 1B, R³ and R⁴ may each be hydrogen, and at least one selected from among R¹, R², R⁵, and R⁶ may be a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

For example, in one or more embodiments, Chemical Formula 1 may be represented by Chemical Formula 1A.

In Chemical Formula 1A, R³ and R⁴ may each be hydrogen, and at least one of R⁵ or R⁶ may be a substituted or unsubstituted C1 to C10 alkyl group.

The compound represented by Chemical Formula 1 may be included in an amount of about 0.1 to about 5 wt %, for example about 0.1 to about 1 wt %, based on 100 wt % of a total amount of the electrolyte solution.

If (e.g., when) the amount of the compound represented by Chemical Formula 1 is within the above range, the rechargeable lithium battery having improved high-temperature storage characteristics and cycle-life characteristics may be implemented.

For example, in one or more embodiments, the compound represented by Chemical Formula 1 may be selected from the compounds of Group 1, or may be, for example, 2-fluoro-1,3,2-dioxaphospholane and 2-fluoro-4-methyl-1,3,2-dioxaphospholane.

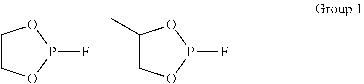

The lithium salt dissolved in the non-organic solvent supplies lithium ions in the rechargeable lithium battery, enables a basic operation of the rechargeable lithium battery, and improves transportation of the lithium ions between positive and negative electrodes.

The lithium salt may be utilized in a concentration in a range of about 0.1 M to about 2.0 M. If (e.g., when) the lithium salt is included at the above concentration range, the electrolyte may have excellent or suitable performance and lithium ion mobility due to optimal or suitable electrolyte conductivity and viscosity.

In one or more embodiments, the lithium salt may include a compound represented by Chemical Formula 2.

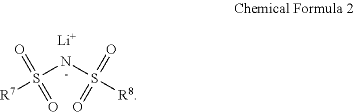

In Chemical Formula 2,

R⁷ and R⁸ may each independently be a fluoro group or a C1 to C4 fluoroalkyl group substituted with at least one fluoro group.

The compound represented by Chemical Formula 2 is a lithium salt having an imide group, and has high thermal stability and moisture stability, low corrosiveness and viscosity, and high electrical conductivity, so that it may realize excellent or suitable performance even under high power conditions and low temperatures.

For example, in one or more embodiments, the compound represented by Chemical Formula 2 may include a compound represented by Chemical Formula 2A, a compound represented by Chemical Formula 2B, a compound represented by Chemical Formula 2C, or a combination thereof.

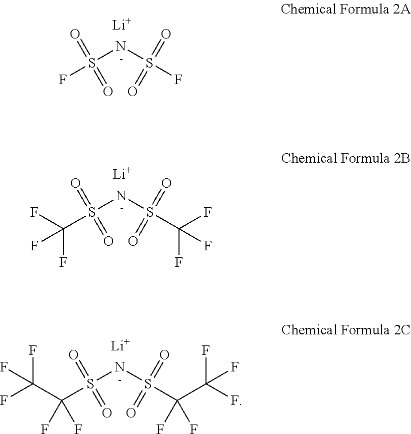 [SMILES: [Li+] ; O=S(=O)(F)NS(=O)(=O)F ; [Li+] ; O=S(=O)(NS(=O)(=O)C(F)(F)F)C(F)(F)F ; [Li+] ; O=S(=O)(NS(=O)(=O)C(F)(F)C(F)(F)F)C(F)(F)C(F)(F)F]

For example, in one or more embodiments, the compound represented by Chemical Formula 2 may include LiN(CₓF₂ₓ₊₁SO₂)(C_{y}F_{2y+1}SO₂), where x and y are natural numbers, for example, integers from 0 to 20. Non-limiting examples thereof may include Li(FSO₂)₂N (lithium bis(fluorosulfonyl)imide: LiFSI), Li(CF₃SO₂)₂N (lithium bis(trifluoromethane sulfonyl)imide): LiTFSI), LIN(SO₂C2F₅)₂, or a combination thereof.

The compound represented by Chemical Formula 2 may be included in an amount of about 5 to about 70 wt %, for example about 10 to about 50 wt %, based on 100 wt % of a total amount of the lithium salt.

If (e.g., when) the amount of the compound represented by Chemical Formula 2 is less than about 5 wt % based on 100 wt % of the total amount of the lithium salt, it is difficult to realize excellent or suitable high-temperature storage characteristics and cycle-life characteristics, and if (e.g., when) it exceeds about 70 wt %, there may be a problem in that aluminum (Al) utilized as a material for a positive electrode substrate (e.g., a positive electrode current collector) and a terminal part is corroded.

In some embodiments, the additive may further include other additives in addition to the aforementioned additives.

The other additives may include at least one selected from among vinylene carbonate (VC), fluoroethylene carbonate (FEC), difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate (VEC), adiponitrile (AN), succinonitrile (SN), polysulfone, 1,3,6-hexane tricyanide (HTCN), propene sultone (PST), propane sultone (PS), lithium tetrafluoroborate (LiBF₄), lithium difluorophosphate (LiPO₂F₂), and 2-fluorobiphenyl (2-FBP).

By further including the aforementioned other additives, cycle-life of the rechargeable lithium battery may be further improved, or gases generated from the positive electrode and the negative electrode may be effectively controlled or reduced during high-temperature storage.

The aforementioned other additives may be included in an amount of about 0.2 wt % to about 20 wt %, about 0.2 to about 15 wt %, or, for example, about 0.2 wt % to about 10 wt %, based on 100 wt % of a total amount of the electrolyte solution for the rechargeable lithium battery.

The aforementioned other additives, if (e.g., when) included within the above contents, may minimize or reduce an increase in film resistance, and thus contribute to improving battery performance.

In one or more embodiments, the lithium salt may further other lithium salts in addition to a lithium salt represented by Chemical Formula 2.

The other lithium salts may include LiPF₆, LiBF₄, lithium difluoro(oxalato)borate (LiDFOB), LiPO₂F₂, LiSbF₆, LiAsF₆, LiC₄F₉SO₃, LiClO₄, LiAlO₂, LiAlCl₄, LiCl, LiI, LiB(C₂O₄)₂ (lithium bis(oxalato)borate: LiBOB), or a combination thereof.

The non-aqueous organic solvent serves as a medium for transmitting ions taking part in the electrochemical reaction of a battery.

The non-aqueous organic solvent may be a carbonate-based, ester-based, ether-based, ketone-based, alcohol-based, or aprotic solvent.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and/or the like. The ester-based solvent may include methyl acetate, ethyl acetate, n-propyl acetate, t-butyl acetate, methylpropionate, ethylpropionate, propylpropionate, decanolide, mevalonolactone, caprolactone, and/or the like. The ether-based solvent may include dibutyl ether, tetraglyme, diglyme, dimethoxyethane, 2-methyltetrahydrofuran, tetrahydrofuran, and/or the like. The ketone-based solvent may include cyclohexanone, and/or the like. The alcohol-based solvent may include ethanol, isopropyl alcohol, and/or the like, and the aprotic solvent may include nitriles such as R—CN (wherein R is a hydrocarbon group having a C2 to C20 linear, branched, or cyclic structure and may include a double bond, an aromatic ring, or an ether bond), and/or the like, amides such as dimethyl formamide, and/or the like, dioxolanes such as 1,3-dioxolane, and/or the like, sulfolanes, and/or the like.

The non-aqueous organic solvent may be utilized at alone or in a mixture, and if (e.g., when) the organic solvent is utilized in a mixture, a mixture ratio may be controlled or selected in accordance with a desirable battery performance.

In one or more embodiments, the carbonate-based solvent may be prepared by mixing a cyclic carbonate and a chain carbonate. If (e.g., when) the cyclic carbonate and chain carbonate are mixed together in a volume ratio of about 5:5 to about 1:9, a performance of the electrolyte solution may be improved.

In some embodiments, the non-aqueous organic solvent may include the cyclic carbonate and the chain carbonate in a volume ratio of about 5:5 to about 2:8, in some embodiments, the cyclic carbonate and the chain carbonate may be included in a volume ratio of about 4:6 to about 2:8.

In some embodiments, the cyclic carbonate and the chain carbonate may be included in a volume ratio of about 3:7 to about 2:8.

In one or more embodiments, the non-aqueous organic solvent may further include an aromatic hydrocarbon-based organic solvent in addition to the carbonate-based solvent. The carbonate-based solvent and the aromatic hydrocarbon-based organic solvent may be mixed in a volume ratio of about 1:1 to about 30:1.

The aromatic hydrocarbon-based organic solvent may be an aromatic hydrocarbon-based compound of Chemical Formula 3.

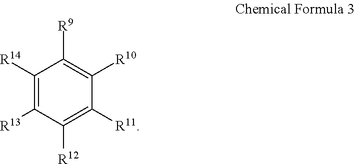

In Chemical Formula 3, R⁹ to R¹⁴ may each independently be the same or different and may each independently be selected from hydrogen, a halogen, a C1 to C10 alkyl group, a haloalkyl group, and a combination thereof.

Non-limiting examples of the aromatic hydrocarbon-based organic solvent may be selected from benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 2,3-difluorotoluene, 2,4-difluorotoluene, 2,5-difluorotoluene, 2,3,4-trifluorotoluene, 2,3,5-trifluorotoluene, chlorotoluene, 2,3-dichlorotoluene, 2,4-dichlorotoluene, 2,5-dichlorotoluene, 2,3,4-trichlorotoluene, 2,3,5-trichlorotoluene, iodotoluene, 2,3-diiodotoluene, 2,4-diiodotoluene, 2,5-diiodotoluene, 2,3,4-triiodotoluene, 2,3,5-triiodotoluene, xylene, and a combination thereof.

The positive electrode may include a positive electrode current collector and a positive electrode active material layer on the positive electrode current collector, and the positive electrode active material layer may include a positive electrode active material.

The positive electrode active material may include lithiated intercalation compounds that reversibly intercalate and deintercalate lithium ions.

For example, in one or more embodiments, a composite oxide of a nickel-containing metal and lithium may be utilized.

Non-limiting examples of the positive electrode active material may include a composite oxide represented by any one of the following chemical formulas.

LiₐA_{1-b}X_{b}D₂ (0.90≤a≤1.8, 0≤b≤0.5); LiₐA_{1-b}X_{b}O_{2-c}D_{c} (0.90≤a≤1.8, 0≤b≤0.5, 0≤c≤0.05); LiₐE_{1-b}X_{b}O_{2-c}D_{c} (0.90≤a≤1.8, 0≤b≤0.5, 0≤c≤0.05); LiₐE_{2-b}X_{b}O_{4-c}D_{c} (0.90≤a≤1.8, 0≤b≤0.5, 0≤c≤0.05); LiₐNi_{1-b-c}Co_{b}X_{c}Dₐ (0.90≤a≤1.8, 0≤b≤0.5, 0≤c≤0.5, 0<a≤2); LiₐNi_{1-b-c}Co_{b}X_{c}O₂₋ₐTₐ (0.90≤a≤1.8, 0≤b≤0.5, 0≤c≤0.05, 0<a<2); LiₐNi_{1-b-c}Co_{b}X_{c}O₂₋ₐT₂ (0.90≤a≤1.8, 0≤b≤0.5, 0≤c≤0.05, 0<a<2); LiₐNi_{1-b-c}Mn_{b}X_{c}Dₐ (0.90≤a≤1.8, 0≤b≤0.5, 0≤c≤0.05, 0<a≤2); LiₐNi_{1-b-c}Mn_{b}X_{c}O₂₋ₐTₐ (0.90≤a≤1.8, 0≤b≤0.5, 0≤c≤0.05, 0<a<2); LiₐNi_{1-b-c}Mn_{b}X_{c}O₂₋ₐT₂ (0.90≤a≤1.8, 0≤b≤0.5, 0≤c≤0.05, 0<a<2); LiₐNi_{b}E_{c}G_{d}O₂ (0.90≤a≤1.8, 0≤b≤0.9, 0≤c≤0.5, 0.001≤d≤0.1); LiₐNi_{b}Co_{c}Mn_{d}GeO₂ (0.90≤a≤1.8, 0≤b≤0.9, 0≤c≤0.5, 0≤d≤0.5, 0.001≤e≤0.1); LiₐNiGbO₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); QO₂; QS₂; LiQS₂; V₂O₅; LiV₂O₅; LiZO₂; LiNiVO₄; Li₍₃₋₁₎J₂(PO₄)₃ (0≤f≤2); Li_{(3-f)}Fe₂(PO₄)₃ (0≤f≤2); LiₐFePO₄(0.90≤a≤1.8)

In the above chemical formulas, A may be selected from Ni, Co, Mn, and a combination thereof; X may be selected from Al, Ni, Co, Mn, Cr, Fe, Mg, Sr, V, a rare earth element, and a combination thereof; D may be selected from O, F, S, P, and a combination thereof; E may be selected from Co, Mn, and a combination thereof; T may be selected from F, S, P, and a combination thereof; G may be selected from Al, Cr, Mn, Fe, Mg, La, Ce, Sr, V, and a combination thereof; Q may be selected from Ti, Mo, Mn, and a combination thereof; Z may be selected from Cr, V, Fe, Sc, Y, and a combination thereof; and J may be selected from V, Cr, Mn, Co, Ni, Cu, and a combination thereof.

The composite oxide may have a coating layer on the surface thereof, or may be mixed with another composite oxide having a coating layer. The coating layer may include at least one coating element compound selected from an oxide of a coating element, a hydroxide of a coating element, an oxyhydroxide of a coating element, an oxycarbonate of a coating element, and a hydroxy carbonate of a coating element. The compound for the coating layer may be amorphous or crystalline. The coating element included in the coating layer may include Mg, Al, Co, K, Na, Ca, Si, Ti, V, Sn, Ge, Ga, B, As, Zr, or a mixture thereof. The coating process may include any coating processes as long as it does not cause any side effects on the properties of the positive electrode active material (e.g., spray coating, dipping), which is well suitable to persons having ordinary skill in the art, so a detailed description thereof is not provided for conciseness.

In one or more embodiments, the positive electrode active material may be, for example, at least one of lithium composite oxides represented by Chemical Formula 4.

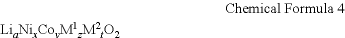

In Chemical Formula 4,
0.9≤a<1.2, 0.8≤x<1.0, 0<y≤0.2, 0<z≤0.2, x+y+z=1, 0≤t≤0.1,
M¹ may be Mn, Al, or a combination thereof, and
M² may be Ni, Co, Mn, Al, Ti, Mg, Zr, Ca, Nb, Fe, P, F, B, or a combination thereof.

In one or more embodiments, in Chemical Formula 4, x may be 0.88≤x<1.0.

A content (e.g., amount) of the positive electrode active material may be about 90 wt % to about 98 wt % based on a total weight of the positive electrode active material layer.

In one or more embodiments, the positive electrode active material layer may include a binder. A content (e.g., amount) of the binder may be about 1 wt % to about 5 wt % based on a total weight of the positive electrode active material layer.

The binder improves binding properties of positive electrode active material particles with one another and with the positive electrode current collector. Non-limiting examples thereof may be polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and/or the like, but embodiments of the present disclosure are not limited thereto.

In one or more embodiments, aluminum (Al) may be utilized as the positive electrode current collector, but embodiments of the present disclosure are not limited thereto.

In one or more embodiments, the negative electrode active material may include a Si composite (e.g., in particle form, e.g., being in the form of a particle or particles).

The Si composite may include a core including Si particles and amorphous carbon. For example, in some embodiments, the Si particles may include at least one selected from among a Si—C composite, SiOₓ (0<x≤2), and a Si alloy.

For example, in one or more embodiments, the Si—C composite (e.g., in particle form, e.g., being in the form of a particle or particles) may include a core including Si particles and amorphous carbon.

A void (e.g., pores) may be included in a central portion of the core of the Si—C composite (e.g., the Si—C composite particle), and a radius of the central portion may correspond to about 30% to about 50% of a radius of the Si—C composite (e.g., the Si—C composite particle).

An average particle diameter of the Si particle may be about 10 nm to about 200 nm.

In the present disclosure, the average particle diameter may be a particle size (D₅₀) at 50% by volume in a cumulative size-distribution curve.

If (e.g., when) the average particle diameter of the Si particle is within the above range, volume expansion occurring during charging and discharging may be suppressed or reduced, and a break in a conductive path due to particle crushing during charging and discharging may be prevented or reduced.

The Si particles may be included in an amount of about 1 wt % to about 60 wt %, for example, about 3 wt % to about 60 wt %, based on a total weight of the Si—C composite.

The central portion does not include (e.g., may exclude) amorphous carbon, and the amorphous carbon may be present only on the surface portion of the negative electrode active material (e.g., on the surface portion of the Si—C composite particle).

The surface portion utilized herein refers to a region from the central portion to the outermost surface of the negative electrode active material particle (e.g., the Si—C composite particle).

In some embodiments, the Si particles are substantially uniformly included in the negative electrode active material as a whole, for example, may be present in a substantially uniform concentration in the central portion and the surface portion thereof.

The amorphous carbon may be soft carbon, hard carbon, a mesophase pitch carbonized product, calcined coke, or a combination thereof.

In one or more embodiments, an amorphous carbon precursor may include a coal-based pitch, mesophase pitch, petroleum-based pitch, coal-based oil, petroleum-based heavy oil, or a polymer resin such as a phenol resin, a furan resin, or a polyimide resin.

The amorphous carbon may be included in an amount of about 1 to about 50 parts by weight, for example, about 5 to about 50 parts by weight, or about 10 to about 50 parts by weight, based on 100 parts by weight of the negative electrode active material.

The Si composite may be included in an amount of about 1 to about 60 wt %, for example, about 3 to about 60 wt %, based on a total weight of the negative electrode active material.

In one or more embodiments, the negative electrode active material may further include crystalline carbon (e.g., in particle form, e.g., being in the form of a particle or particles) together with the aforementioned Si composite.

If (e.g., when) the negative electrode active material includes the Si composite and the crystalline carbon together, the Si composite and the crystalline carbon may be included in the form of a mixture, in which the Si composite and the crystalline carbon may be included in a weight ratio of about 1:99 to about 50:50. In some embodiments, the Si composite and crystalline carbon may be included in a weight ratio of about 5:95 to about 20:80.

The crystalline carbon may include, for example, graphite, for example, may include natural graphite, artificial graphite, or a mixture thereof.

An average particle diameter of the crystalline carbon may be about 5 μm to about 30 μm.

In the present disclosure, the average particle diameter may be a particle size (D₅₀) at 50% by volume in a cumulative size-distribution curve.

In the negative electrode active material layer, the negative electrode active material may be included in an amount of about 95 wt % to about 99 wt % based on a total weight of the negative electrode active material layer.

In one or more embodiments of the present disclosure, the negative electrode active material layer may include a binder, and optionally a conductive material. In the negative electrode active material layer, a content (e.g., amount) of the binder may be about 1 wt % to about 5 wt % based on a total weight of the negative electrode active material layer. If (e.g., when) the negative electrode active material layer includes a conductive material, the negative electrode active material layer may include about 90 wt % to about 98 wt % of the negative electrode active material, about 1 wt % to about 5 wt % of the binder, and about 1 wt % to about 5 wt % of the conductive material.

The binder serves to well bind the negative electrode active material particles to each other and also to well bind the negative electrode active material to the negative electrode current collector. The binder may include a non-water-soluble binder, a water-soluble binder, or a combination thereof.

The non-water-soluble binder may be selected from polyvinylchloride, carboxylated polyvinylchloride, polyvinylfluoride, polyurethane, polytetrafluoroethylene, polyvinylidene fluoride, polyethylene, polypropylene, polyamideimide, polyimide, or a combination thereof.

The water-soluble binder may be a rubber-based binder or a polymer resin binder. The rubber-based binder may be selected from a styrene-butadiene rubber, an acrylated styrene-butadiene rubber (SBR), an acrylonitrile-butadiene rubber, an acrylic rubber, a butyl rubber, a fluorine rubber, and a combination thereof. The polymer resin binder may be selected from polytetrafluoroethylene, ethylenepropylenecopolymer, polyethyleneoxide, polyvinylpyrrolidone, polyepichlorohydrin, polyphosphazene, polyacrylonitrile, polystyrene, an ethylenepropylenediene copolymer, polyvinylpyridine, chlorosulfonated polyethylene, latex, a polyester resin, an acrylic resin, a phenolic resin, an epoxy resin, polyvinyl alcohol, and a combination thereof.

If (e.g., when) the water-soluble binder is utilized as a binder for the negative electrode, a cellulose-based compound may be further utilized to provide viscosity as a thickener. The cellulose-based compound may include one or more of carboxymethyl cellulose, hydroxypropylmethyl cellulose, methyl cellulose, or alkali metal salts thereof. The alkali metals may be Na, K, or Li. Such a thickener may be included in an amount of about 0.1 parts by weight to about 3 parts by weight based on 100 parts by weight of the negative electrode active material.

The conductive material may be included to provide electrode conductivity, and any electrically conductive material may be utilized as the conductive material unless it causes a chemical change. Non-limiting examples of the conductive material may include a carbon-based material such as natural graphite, artificial graphite, carbon black, acetylene black, ketjen black, a carbon fiber, and/or the like; a metal-based material of a metal powder or a metal fiber including copper, nickel, aluminum silver, and/or the like; a conductive polymer such as a polyphenylene derivative; or a mixture thereof.

The negative current collector may be selected from a copper foil, a nickel foil, a stainless steel foil, a titanium foil, a nickel foam, a copper foam, a polymer substrate coated with a conductive metal, and a combination thereof.

In one or more embodiments, a separator may be present between the positive electrode and the negative electrode depending on the type or kind of the rechargeable lithium battery. Such a separator may include polyethylene, polypropylene, polyvinylidene fluoride, or multi-layers thereof such as a polyethylene/polypropylene double-layered separator, a polyethylene/polypropylene/polyethylene triple-layered separator, or a polypropylene/polyethylene/polypropylene triple-layered separator.

Hereinafter, examples of the present disclosure and comparative examples are described in more detail. These examples, however, are not in any sense to be interpreted as limiting the scope of the present disclosure.

### Manufacture of Rechargeable Lithium Battery Cell

### Example 1

LiNi_{0.88}Co_{0.105}Al_{0.015}O₂ as a positive electrode active material, polyvinylidene fluoride as a binder, and carbon nanotubes (average length: 50 μm) as a conductive material were mixed in a weight ratio of 96:3:1, respectively, and were dispersed in N-methyl pyrrolidone to prepare a positive electrode active material slurry.

The positive electrode active material slurry was coated on a 20 μm-thick Al foil, dried at 100° C., and then pressed to prepare a positive electrode.

As a negative electrode active material, a mixture of artificial graphite and a Si—C composite in a weight ratio of 93:7 was utilized, and the negative electrode active material, a styrene-butadiene rubber binder, and carboxymethyl cellulose were mixed in a weight ratio of 98:1:1, respectively, and dispersed in distilled water to prepare a negative electrode active material slurry.

The Si—C composite has a core including artificial graphite and silicon particles and a coal-based pitch coated on the surface of the core, wherein a content (e.g., amount) of the Si—C composite is about 1.0 wt % based on a total weight of the negative electrode active material. As an example, the Si—C composite may be a particle (e.g., a secondary particle) having the core including the artificial graphite and the silicon particles and a coal-based pitch coated on the surface of the core (e.g., coated as a shell on the core), wherein the content (e.g., amount) of the Si—C composite is about 1.0 wt % based on the total weight of the negative electrode active material.

The negative electrode active material slurry was coated on a 10 μm-thick Cu foil, dried at 100° C., and then pressed to prepare a negative electrode.

An electrode assembly was prepared by assembling the prepared positive and negative electrodes and a polyethylene separator having a thickness of 25 μm, and an electrolyte solution was injected to prepare a rechargeable lithium battery cell.

A composition of an electrolyte solution is as follows.

### Composition of Electrolyte Solution

Lithium salt: As a lithium salt, 10 wt % of a lithium salt represented by Chemical Formula 2A (hereinafter referred to as LiFSI) and 90 wt % of a LiPF₆ were included based on 100 wt % of the total amount of the lithium salt, and a concentration of the lithium salt is 1.5 M.

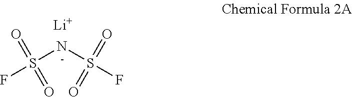

Solvent: ethylene carbonate: ethylmethyl carbonate: dimethyl carbonate (EC:EMC:DMC=volume ratio of 20:10:70)

Additive: 1 wt % of 2-fluoro-4-methyl-1,3,2-dioxaphospholane based on 100 wt % of the total amount of the electrolyte solution

### Examples 2 to 4

Each rechargeable lithium battery cell was manufactured in substantially the same manner as in Example 1 except that the content (e.g., amount) of the Si—C composite was respectively changed into 20 wt %, 40 wt %, and 60 wt % based on the total weight of the negative electrode active material to manufacture a negative electrode.

### Example 5

A rechargeable lithium battery cell was manufactured in substantially the same manner as in Example 1 except that 35 wt % of a lithium salt represented by Chemical Formula 2A was utilized based on 100 wt % of the total amount of the lithium salt.

### Examples 6 to 8

Each rechargeable lithium battery cell was manufactured in substantially the same manner as in Example 5 except that the content (e.g., amount) of the Si—C composite was respectively changed into 20 wt %, 40 wt %, and 60 wt % based on the total weight of the negative electrode active material to manufacture a negative electrode.

### Example 9

A rechargeable lithium battery cell was manufactured in substantially the same manner as in Example 1 except that 50 wt % of a lithium salt represented by Chemical Formula 2A was utilized based on 100 wt % of the total amount of the lithium salt.

### Example 10 to 12

Each rechargeable lithium battery cell was manufactured in substantially the same manner as in Example 9 except that the content (e.g., amount) of the Si—C composite was respectively changed into 20 wt %, 40 wt %, and 60 wt % based on the total weight of the negative electrode active material to manufacture a negative electrode.

### Comparative Example 1

A rechargeable lithium battery cell was manufactured in substantially the same manner as in Example 1 except that an electrolyte solution including no (e.g., excluding) 2-fluoro-4-methyl-1,3,2-dioxaphospholane and a lithium salt including no (e.g., excluding a) lithium salt represented by Chemical Formula 2A were utilized.

### Comparative Examples 2 to 4

Each rechargeable lithium battery cell was manufactured in substantially the same manner as in Comparative Example 1 except that the content (e.g., amount) of the Si—C composite was respectively changed into 20 wt %, 40 wt %, and 60 wt % based on the total weight of the negative electrode active material to manufacture a negative electrode.

### Comparative Example 5

A rechargeable lithium battery cell was manufactured in substantially the same manner as in Example 1 except that an electrolyte solution including no (e.g., excluding) 2-fluoro-4-methyl-1,3,2-dioxaphospholane was utilized.

### Comparative Examples 6 to 8

Each rechargeable lithium battery cell was manufactured in substantially the same manner as in Comparative Example 5 except that the content (e.g., amount) of the Si—C composite was respectively changed into 20 wt %, 40 wt %, and 60 wt % based on the total weight of the negative electrode active material to manufacture a negative electrode.

### Comparative Example 9

A rechargeable lithium battery cell was manufactured in substantially the same manner as in Example 1 except that an electrolyte solution including no (e.g., excluding a) lithium salt represented by Chemical Formula 2A was utilized.

### Comparative Examples 10 to 12

Each rechargeable lithium battery cell was manufactured in substantially the same manner as in Comparative Example 9 except that the content (e.g., amount) of the Si—C composite was respectively changed into 20 wt %, 40 wt %, and 60 wt % based on the total weight of the negative electrode active material to manufacture a negative electrode.

### Comparative Example 13

A rechargeable lithium battery cell was manufactured in substantially the same manner as in Example 1 except that 90 wt % of a lithium salt represented by Chemical Formula 2A based on 100 wt % of the total amount of the lithium salt was utilized.

### Comparative Examples 14 to 16

Each rechargeable lithium battery cell was manufactured in substantially the same manner as in Comparative Example 13 except that the content (e.g., amount) of the Si—C composite was respectively changed into 20 wt %, 40 wt %, and 60 wt % based on the total weight of the negative electrode active material to manufacture a negative electrode.

Tables 1 and 2 shows that composition contents and evaluation results of each of the manufactured rechargeable lithium battery cells. The evaluation results according to a content (e.g., amount) of a lithium salt are shown in Table 1, and in order to show the compositions according to each Si—C composite with or without additives and the evaluation results, some of the data of Table 1 are shown in Table 2.

### Evaluation 1: Evaluation of High-Temperature Charge/Discharge Cycle Capacity Characteristics

The rechargeable lithium battery cells according to Examples 1 to 12, and Comparative Examples 1 to 16 were each evaluated with respect to cycle characteristics after the charges and discharges under the following conditions.

The cells each were 300 cycles charged and discharged within a range of 2.5 V to 4.2 V at a C-rate of 0.5 C at a high temperature of 60° C., and a ratio of discharge capacity (mAh) after the 300 cycles to the initial discharge capacity (mAh) was calculated and then, provided as capacity retention (%) in Tables 1 and 2.

Evaluation 2: Evaluation of room-temperature charge/discharge cycle resistance characteristics

The rechargeable lithium battery cells of Examples 1 to 12 and Comparative Examples 1 to 16 were each measured with respect to ΔV/ΔI (voltage change/current change) as initial DC resistance (DCIR).

The cells were each measured with respect to DC resistance after 300 cycles charges and discharges at a C-rate of 0.5 C within a range of 2.5 V to 4.2 V at room temperature (25° C.), which was utilized to calculate a resistance (DCIR) increase rate (%) according to Equation 2, and the results are shown in Tables 1 and 2.

DCIR change rate=(DCIR after 300 cycles/Initial DCIR)×100% Equation 2

In Tables 1 and 2, the content (e.g., amount) of the Si—C composite was based on 100 wt % of the total weight of the negative electrode active material, the content (e.g., amount) of the 2-fluoro-4-methyl-1,3,2-dioxaphospholane was based on 100 wt % of the total amount of the electrolyte solution, and the content (e.g., amount) of LiFSI was based on 100 wt % of the total amount of the lithium salt.

TABLE 1

| | Negative | | | Evaluation of battery characteristics | | |
|---|---|---|---|---|---|---|
| | electrode | | | | High- | Room- |
| | active | Electrolyte solution | | | temperature | temperature |
| | material | Content of 2- | | | cycle-life | cycle-life |
| | Content | fluoro-4- | | | capacity | resistance |
| | of Si—C | methyl-1,3,2- | Content | Initial | retention | increase rate |
| | composite | dioxaphospholane | of LiFSI | resistance | @300cy | @300cy |
| | (wt %) | (wt %) | (wt %) | (mΩ) | (%) | (%) |
| Comp. Ex. 1 | 1 | 0 | 0 | 31.1 | 75.3 | 250.6 |
| Comp. Ex. 5 | | | 10 | 40.4 | 60.2 | 275.7 |
| Comp. Ex. 9 | | 1 | 0 | 43.5 | 67.8 | 268.1 |
| Ex. 1 | | | 10 | 13.4 | 94.1 | 120.3 |
| Ex. 5 | | | 35 | 11.5 | 97.9 | 127.8 |
| Ex. 9 | | | 50 | 14.6 | 90.4 | 152.9 |
| Comp. Ex. 13 | | | 90 | 84 | 52.7 | 325.8 |
| Comp. Ex. 2 | 20 | 0 | 0 | 46.7 | 67 | 401 |
| Comp. Ex. 6 | | | 10 | 60.6 | 53.6 | 441.1 |
| Comp. Ex. 10 | | 1 | 0 | 65.3 | 60.3 | 429 |
| Ex. 2 | | | 10 | 20.1 | 92.1 | 159.7 |
| Ex. 6 | | | 35 | 17.3 | 95.8 | 167.7 |
| Ex. 10 | | | 50 | 21.9 | 88.5 | 185.9 |
| Comp. Ex. 14 | | | 90 | 126 | 46.9 | 521.2 |
| Comp. Ex. 3 | 40 | 0 | 0 | 52.9 | 57.2 | 451.1 |
| Comp. Ex. 7 | | | 10 | 68.7 | 45.8 | 496.2 |
| Comp. Ex. 11 | | 1 | 0 | 74 | 51.5 | 482.7 |
| Ex. 3 | | | 10 | 22.7 | 85.8 | 188.4 |
| Ex. 7 | | | 35 | 19.6 | 89.3 | 202.4 |
| Ex. 11 | | | 50 | 24.8 | 82.4 | 220.1 |
| Comp. Ex. 15 | | | 90 | 142.7 | 40.1 | 586.4 |
| Comp. Ex. 4 | 60 | 0 | 0 | 65.3 | 45.9 | 526.3 |
| Comp. Ex. 8 | | | 10 | 84.9 | 36.7 | 578.9 |
| Comp. Ex. 12 | | 1 | 0 | 91.4 | 41.3 | 563.1 |
| Ex. 4 | | | 10 | 28.1 | 80.4 | 234.9 |
| Ex. 8 | | | 35 | 24.2 | 83.6 | 241.6 |
| Ex. 12 | | | 50 | 30.7 | 77.2 | 244 |
| Comp. Ex. 16 | | | 90 | 176.3 | 32.2 | 684.1 |

TABLE 2

| | | | Negative | Evaluation of battery characteristics | | |
|---|---|---|---|---|---|---|
| | | | electrode | | High- | Room- |
| | Electrolyte solution | | active | | temperature | temperature |
| | | Content of 2- | material | | cycle-life | cycle-life |
| | | fluoro-4- | Content | | capacity | resistance |
| | Content | methyl-1,3,2- | of Si—C | Initial | retention | increase rate |
| | of LiFSI | dioxaphospholane | composite | resistance | @300cy | @300cy |
| | (wt %) | (wt %) | (wt %) | (mΩ) | (%) | (%) |
| Comp. Ex. 5 | 10 | 0 | 1 | 40.4 | 60.2 | 275.7 |
| Ex. 1 | | 1 | | 13.4 | 94.1 | 120.3 |
| Comp. Ex. 6 | 10 | 0 | 20 | 60.6 | 53.6 | 441.1 |
| Ex. 2 | | 1 | | 20.1 | 92.1 | 159.7 |
| Comp. Ex. 7 | 10 | 0 | 40 | 68.7 | 45.8 | 496.2 |
| Ex. 3 | | 1 | | 22.7 | 85.8 | 188.4 |
| Comp. Ex. 8 | 10 | 0 | 60 | 84.9 | 36.7 | 578.9 |
| Ex. 4 | | 1 | | 28.1 | 80.4 | 234.9 |

Referring to Table 1, a high-temperature capacity retention and a room-temperature resistance increase rate according to a content (e.g., amount) of LiFSI were confirmed.

For example, each of the examples having LiFSI content (e.g., amount) of 10, 35, and 50 wt % based on 100 wt % of the total amount of the lithium salt each exhibited high high-temperature capacity retention and a low room-temperature resistance increase rate.

In contrast, each of the comparative examples having LiFSI content (e.g., amount) of 0 or 90 wt % based on 100 wt % of the total amount of the lithium salt each exhibited low high-temperature capacity retention and a high room-temperature resistance increase rate.

Referring to Table 2, when a content (e.g., amount) of LiFSI was the same, for different content (e.g., amount) of the Si—C composite, the high-temperature capacity retention and the room-temperature resistance increase rate according to the presence or absence of an additive (2-fluoro-4-methyl-1,3,2-dioxaphospholane) were confirmed.

Comparing Comparative Example 5 with Example 1, Comparative Example 6 with Example 2, Comparative Example 7 with Example 3, and Comparative Example 8 with Example 4, the examples including the additive (2-fluoro-4-methyl-1,3,2-dioxaphospholane) each exhibited high high-temperature capacity retention and a low room-temperature resistance increase rate.

Resultantly, when an electrolyte solution including an additive (2-fluoro-4-methyl-1,3,2-dioxaphospholane) and a negative electrode including a Si—C composite were utilized with a lithium salt represented by Chemical Formula 2A in a specific weight range, resistance characteristics and cycle-life characteristics were concurrently (e.g., simultaneously) and significantly improved. In contrast, when one of the aforementioned three materials was missed, or even if the three materials were all included, but the lithium salt represented by Chemical Formula 2A was utilized out of the specific weight range(s), the desired or suitable effect was not achieved.

Accordingly, the rechargeable lithium battery cell according to one or more embodiments may not only realize excellent or suitable cycle characteristics due to improved impregnation properties of the electrolyte solution of the present disclosure but also exhibit improved high-temperature stability due to reduced resistance after high-temperature storage.

In the present disclosure, it should be understood that terms such as “comprise(s),” “include(s),” or “have/has” are intended to designate the presence of an embodied feature, number, step, element, or a combination thereof, but it does not preclude the possibility of the presence or addition of one or more other features, number, step, element, or a combination thereof.

Herein, “or” is not to be construed as an exclusive meaning, for example, “A or B” is construed to include A, B, A+B, and/or the like. Further, as used herein, the term “and/or” includes any and all combinations of one or more of the associated listed items. The “/” utilized herein may be interpreted as “and” or as “or” depending on the situation. Expressions such as “at least one of,” “one of,” and “selected from,” when preceding a list of elements, modify the entire list of elements and do not modify the individual elements of the list. For example, “at least one of a, b, or c”, “at least one of a, b, and/or c”, “at least one selected from a, b, and c”, “at least one selected from among a to c”, etc. may indicate only a, only b, only c, both (e.g., simultaneously) a and b, both (e.g., simultaneously) a and c, both (e.g., simultaneously) b and c, all of a, b, and c, or variations thereof.

In the drawings, the thickness of layers, films, panels, regions, etc., are exaggerated for clarity and like reference numerals designate like elements throughout, and duplicative descriptions thereof may not be provided the specification.

It will be understood that when an element such as a layer, film, region, or substrate is referred to as being “on” another element, it can be directly on the other element or intervening elements may also be present. In contrast, when an element is referred to as being “directly on” another element, there are no intervening elements present.

As utilized herein, the singular forms “a,” “an,” and “the” are intended to include the plural forms as well, unless the context clearly indicates otherwise. Further, the utilization of “may” when describing embodiments of the present disclosure refers to “one or more embodiments of the present disclosure”.

As utilized herein, the term “substantially,” “about,” and similar terms are utilized as terms of approximation and not as terms of degree, and are intended to account for the inherent deviations in measured or calculated values that would be recognized by those of ordinary skill in the art. “About” or “approximately,” as utilized herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within +30%, 20%, 10%, 5% of the stated value.

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

In the present disclosure, when particles are spherical, “size” or “diameter” indicates a particle diameter or an average particle diameter, and when the particles are non-spherical, the “size” or “diameter” indicates a major axis length or an average major axis length. That is, when particles are spherical, “diameter” indicates a particle diameter, and when the particles are non-spherical, the “diameter” indicates a major axis length. The size or diameter of the particles may be measured utilizing a scanning electron microscope or a particle size analyzer. As the particle size analyzer, for example, HORIBA, LA-950 laser particle size analyzer, may be utilized. When the size of the particles is measured utilizing a particle size analyzer, the average particle diameter (or size) is referred to as D₅₀. D₅₀ refers to the average diameter (or size) of particles whose cumulative volume corresponds to 50 vol % in the particle size distribution (e.g., cumulative distribution), and refers to the value of the particle size corresponding to 50% from the smallest particle when the total number of particles is 100% in the distribution curve accumulated in the order of the smallest particle size to the largest particle size.

While the present disclosure has been described in connection with what is presently considered to be practical example embodiments, it is to be understood that the present disclosure is not limited to the disclosed embodiments. In contrast, it is intended to cover one or more suitable modifications and equivalent arrangements included within the spirit and scope of the appended claims and equivalents thereof.

### REFERENCE NUMERALS

100: rechargeable lithium battery
112: negative electrode
113: separator
114: positive electrode
120: battery case
140: sealing member

What is claimed is:

1. A rechargeable lithium battery, comprising
a positive electrode comprising a positive electrode active material;
a negative electrode comprising a negative electrode active material; and
an electrolyte solution comprising a non-aqueous organic solvent, a lithium salt, and an additive,
wherein the negative electrode active material comprises a Si composite,
the additive comprises a compound represented by Chemical Formula 1,
the lithium salt comprises a compound represented by Chemical Formula 2, and
the compound represented by Chemical Formula 2 is in an amount of about 5 to about 70 wt % based on 100 wt % of a total amount of the lithium salt: 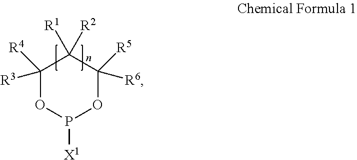
wherein, in Chemical Formula 1,
X¹ is a fluoro group, a chloro group, a bromo group, or an iodo group;
R¹ to R⁶ are each independently hydrogen, a cyano group, a substituted or unsubstituted C1 to C20 alkyl group, a substituted or unsubstituted C1 to C20 alkoxy group, a substituted or unsubstituted C2 to C20 alkenyl group, a substituted or unsubstituted C2 to C20 alkynyl group, a substituted or unsubstituted C3 to C20 cycloalkyl group, a substituted or unsubstituted C6 to C20 aryl group, or a substituted or unsubstituted C2 to C20 heteroaryl group; and
n is an integer of 0 or 1; 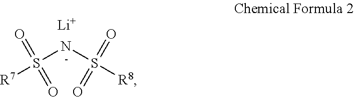
and
wherein, in Chemical Formula 2,
R⁷ and R⁸ are each independently a fluoro group or a C1 to C4 fluoroalkyl group substituted with at least one fluoro group.

2. The rechargeable lithium battery as claimed in claim 1, wherein
Chemical Formula 1 is represented by Chemical Formula 1A or Chemical Formula 1B: 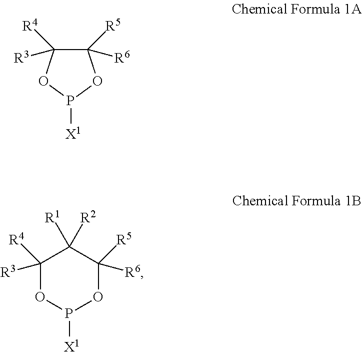
and
wherein, in Chemical Formula 1A and Chemical Formula 1B,
X¹ is a fluoro group, a chloro group, a bromo group, or an iodo group, and
R¹ to Re are each independently hydrogen, a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

3. The rechargeable lithium battery as claimed in claim 2, wherein
R³ and R⁴ of Chemical Formula 1A are each hydrogen, and
at least one of R⁵ or R⁶ is a substituted or unsubstituted C1 to C10 alkyl group, a substituted or unsubstituted C1 to C10 alkoxy group, a substituted or unsubstituted C2 to C10 alkenyl group, or a substituted or unsubstituted C2 to C10 alkynyl group.

4. The rechargeable lithium battery as claimed in claim 1, wherein
the compound represented by Chemical Formula 1 is in an amount of about 0.1 to about 1 wt % based on 100 wt % of a total amount of the electrolyte solution.

5. The rechargeable lithium battery as claimed in claim 1, wherein
the Si composite comprises a core comprising Si particles and amorphous carbon.

6. The rechargeable lithium battery as claimed in claim 5, wherein
the core comprising the Si particles comprises at least one of a Si—C composite, SiOₓ (0<x≤2), or a Si alloy.

7. The rechargeable lithium battery as claimed in claim 6, wherein
the Si—C composite comprises the core comprising the Si particles and the amorphous carbon.

8. The rechargeable lithium battery as claimed in claim 7, wherein
a central portion of the core of the Si—C composite comprises voids.

9. The rechargeable lithium battery as claimed in claim 8, wherein
a radius of the central portion corresponds to about 30% to about 50% of a radius of the Si—C composite, and
an average particle diameter of the Si particles is about 10 nm to about 200 nm.

10. The rechargeable lithium battery as claimed in claim 8, wherein
the central portion does not include any amorphous carbon, and the amorphous carbon is present only on a surface portion of the Si—C composite.

11. The rechargeable lithium battery as claimed in claim 7, wherein
the negative electrode active material further comprises crystalline carbon.

12. The rechargeable lithium battery as claimed in claim 11, wherein
the crystalline carbon comprises graphite, and
the graphite comprises natural graphite, artificial graphite, or a mixture thereof.

13. The rechargeable lithium battery as claimed in claim 1, wherein
an amount of the Si composite is about 1.0 to about 60 wt % based on a total weight of the negative electrode active material.

14. The rechargeable lithium battery as claimed in claim 7, wherein
the amorphous carbon comprises soft carbon, hard carbon, mesophase pitch carbonized product, calcined coke, or a mixture thereof.

15. The rechargeable lithium battery as claimed in claim 1, wherein
the compound represented by Chemical Formula 1 is at least one selected from compounds of Group 1:

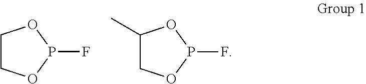

16. The rechargeable lithium battery as claimed in claim 1, wherein
the compound represented by Chemical Formula 2 comprises a compound represented by Chemical Formula 2A, a compound represented by Chemical Formula 2B, a compound represented by Chemical Formula 2C, or a combination thereof:

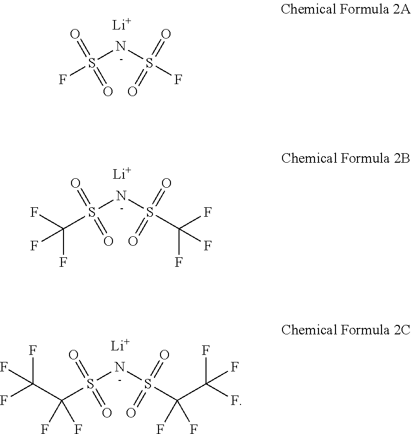 [SMILES: [Li+] ; O=S(=O)(F)NS(=O)(=O)F ; [Li+] ; O=S(=O)(NS(=O)(=O)C(F)(F)F)C(F)(F)F ; [Li+] ; O=S(=O)(NS(=O)(=O)C(F)(F)C(F)(F)F)C(F)(F)C(F)(F)F]

17. The rechargeable lithium battery as claimed in claim 1, wherein
the compound represented by Chemical Formula 2 is in an amount of about 10 to about 50 wt % based on 100 wt % of the total amount of the lithium salt.

18. The rechargeable lithium battery as claimed in claim 1, wherein
the additive further comprises at least one selected from other additives of vinylene carbonate, fluoroethylene carbonate, difluoroethylene carbonate, chloroethylene carbonate, dichloroethylene carbonate, bromoethylene carbonate, dibromoethylene carbonate, nitroethylene carbonate, cyanoethylene carbonate, vinylethylene carbonate, adiponitrile, succinonitrile, 1,3,6-hexane tricyanide, propene sultone, propane sultone, lithium tetrafluoroborate, lithium difluorophosphate, and 2-fluoro biphenyl.

19. The rechargeable lithium battery as claimed in claim 1, wherein
the positive electrode active material is at least one lithium composite oxide represented by Chemical Formula 4: 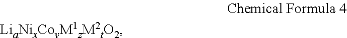
and
wherein, in Chemical Formula 4,
0.9≤a<1.2, 0.8≤x<1.0, 0<y≤0.2, 0<z≤0.2, x+y+z=1, 0≤t≤0.1,
M¹ is Mn, Al, or a combination thereof, and
M² is Ni, Co, Mn, Al, Ti, Mg, Zr, Ca, Nb, Fe, P, F, B, or a combination thereof.

20. The rechargeable lithium battery as claimed in claim 19, wherein in Chemical Formula 4, x is 0.88≤x<1.0.
